(19) United States
(12) Patent Application Publication
(10) Pub. No.: US 2022/0392279 A1
(43) Pub. Date: Dec. 8, 2022

(54) METHOD AND DEVICE FOR CONTROLLING A VEHICLE COMMUNICATION DEVICE

(71) Applicant: PSA AUTOMOBILES SA, Poissy (FR)

(72) Inventors: Sharique KHAN, SCEAUX (FR); Alexandre FROMION, ANTONY (FR)

(21) Appl. No.: 17/770,261

(22) PCT Filed: Oct. 21, 2020
(86) PCT No.: PCT/FR2020/051900

§ 371 Date: Apr. 19, 2022

(30) Foreign Application Priority Data
Nov. 26, 2019 (FR) 1913206

(51) Int. Cl. G07C 5/08; H04W 4/48

(52) U.S. Cl. CPC G07C 5/0808; H04W 4/48

(57) ABSTRACT

The invention relates to a method and device for controlling a vehicle communication device (11). To that end, information on the temperature in the communication device (11) is received. This temperature information is, for example, received from a temperature sensor integrated into the communication device (11). Control parameters for functions performed by the communication device (11) are then controlled, for example in order to deactivate all or part of one or more functions, according to the one or more temperatures received.

### CROSS-REFERENCE TO RELATED APPLICATIONS

This application is the US National Stage under 35 USC § 371 of International Application No. PCT/FR2020/051900, filed 21 Oct. 2020 which claims priority to French Application No. 1913206 filed 26 Nov. 2019, both of which are incorporated herein by reference.

### TECHNICAL FIELD

The invention relates to methods and devices for controlling a vehicle communication device, in particular of the automobile type. The invention relates more particularly to a method and a device for controlling the temperature of a communication device, for example a vehicle telematic control unit.

### BACKGROUND

Modern vehicles embed communication systems or devices enabling the vehicles to communicate and exchange information and data with their environment, for example with other vehicles, a network infrastructure, and telecommunications equipment.

Such a communication device generally has a complex architecture to ensure a variety of communications that are based in particular on different protocols and/or frequency bands, in connection with other devices of the vehicle's on-board system, such as computers with which the communication device exchanges information or data.

Since the number of functions provided by such a communication device is large, this device is sometimes very busy, which can generate overheating problems, which is synonymous with the risk of premature wear of at least some of the components of this communication device.

### BRIEF SUMMARY

An object of the disclosed method and device is to reduce the risks of premature wear of a vehicle communication device.

Another object is to reduce the risks of overheating of a vehicle communication device.

According to a first aspect, a method is disclosed for communicating with a vehicle, the method comprising the following steps:
receiving at least one item of information representative of at least one temperature in the communication device; and
controlling control parameters of functions performed by the communication device as a function of the at least one item of information.

According to a variant, the control parameters are controlled so as to deactivate, at least in part, each function of a set of functions comprising at least one of the functions performed by the communication device when the at least one item of information is representative of a temperature increase above a threshold value in the communication device.

According to another variant, the assembly comprises a determined number of functions, the determined number being a function of the increase in temperature, the determined number increasing with the increase in temperature.

According to an additional variant, the control parameters are controlled according to a first determined order to at least partially deactivate each function of the assembly.

According to an additional variant, the method further comprises a step of cooling the communication device when the at least one item of information is representative of an increase in temperature beyond said threshold value in the communication device.

According to yet another variant, each function of the set of functions deactivated at least in part is reactivated when the at least one item of information is representative of a decrease in temperature below the threshold value in the communication device.

According to another variant, the control parameters are controlled according to a second determined order to reactivate each function of the assembly.

According to a second aspect, a control device is provided for controlling a vehicle communication device, the control device comprising a memory associated with a processor configured to implement the steps of the method according to the first aspect.

According to a variant, the control device further comprises at least one temperature sensor configured to measure the temperature in the communication device.

According to a third aspect, a vehicle, for example of the automobile type, comprises a control device as described above according to the second aspect.

According to a fourth aspect, a computer program comprises instructions suitable for executing the steps of the method according to the first aspect , in particular when the computer program is executed by at least one processor.

Such a computer program may use any programming language, and be in the form of source code, object code, or intermediate code between source code and object code, such as in a partially compiled form, or in any other desirable form.

According to a fifth aspect, a computer-readable recording medium on which is recorded a computer program comprises instructions for executing the steps of the method according to the first aspect.

On the one hand, the recording medium may be any entity or device capable of storing the program. For example, the medium may comprise a storage means, such as a ROM memory, a CD-ROM or a ROM memory of the microelectronic circuit type, or even a magnetic recording means or a hard disk.

On the other hand, this recording medium may also be a transmissible medium such as an electrical or optical signal, such a signal being able to be conveyed via an electrical or optical cable, by conventional or hertzian radio or by self-directed laser beam or by other means. The computer program may in particular be downloaded from an Internet-type network.

Alternatively, the recording medium may be an integrated circuit in which the computer program is incorporated, the integrated circuit being suitable for executing or for being used in the execution of the method in question.

### BRIEF DESCRIPTION OF THE FIGURES

Other features and advantages of the invention will emerge from the description of the non-limiting embodiments of the invention below, with reference to the appended FIGS. 1 to 3, in which:

FIG. 1 schematically illustrates an on-board system comprising a communication device of a vehicle;

FIG. 2 schematically illustrates a device for controlling the communication device of FIG. 1; and

FIG. 3 illustrates a flowchart of the different steps of a method for controlling the communication device of FIG. 1.

### DETAILED DESCRIPTION

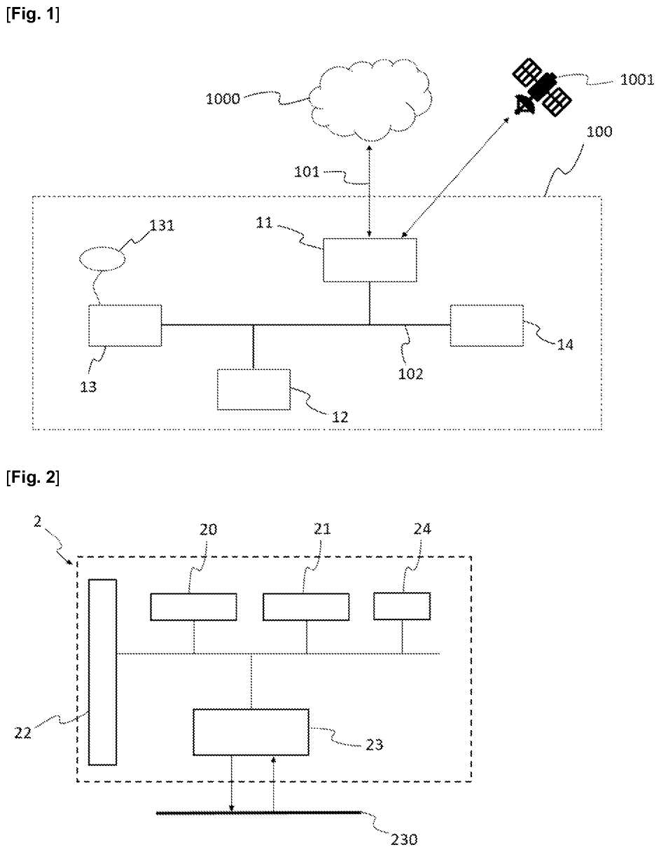

A method and a device for controlling a vehicle communication device will now be described hereinafter with reference jointly to FIGS. 1 to 3.

According to a particular and non-limiting embodiment of the invention, a method for controlling a communication device of a vehicle comprises receiving item(s) of temperature information from the communication device. This temperature information is for example received from a temperature sensor integrated in the communication device. Function control parameters provided by the communication device are then controlled (for example to deactivate all or part of one or more functions) as a function of the temperature(s) received.

Controlling control parameters of certain functions of the communication device as a function of the temperature allows control of the functional load of the communication device as a function of the temperature, which makes it possible, for example, to reduce the load of the device if the temperature is too high. A reduction in the functional load ensured by the device leads to a reduction in the operation of certain components, which will then heat up less, ultimately allowing a reduction in the temperature of the communication device.

Controlling the parameters that control the functions provided by the communication device allows control of the temperature inside the communication device and makes it possible to avoid excessive overheating. This reduces the risk of premature wear linked to overheating.

FIG. 1 schematically illustrates an on-board system 100 in a vehicle.

The system 100 is advantageously embedded in a vehicle, for example of the automobile type. The system 100, for example, comprises a communication device 11, also called a communication box. This communication device corresponds for example to a telematic control unit (or TCU). The communication device is connected to one or more computers 12, 13, 14, for example computers of the ECU (Electronic Control Unit) type. An ECU is made up of an electronic computer and one or more on-board software programs that perform one or more servo-controls. The communication device 11 and the computers 12, 13 and 14 form, for example, a multiplexed architecture for performing various useful services for the correct operation of the vehicle and for assisting the driver and/or the passengers of the vehicle in controlling the vehicle.

The communication device 11 and the computers 12, 13 and 14 communicate and exchange data with each other via one or more computer buses 102, for example a communication bus of the CAN (“Controller Area Network”), CAN FD (“Controller Area Network Flexible Data-Rate”), FlexRay (according to ISO 17458) or Ethernet (according to ISO/IEC 802-3) data bus type.

The communication device 11 is connected to an external device 1000 via a wired or wireless connection or link 101. The external device 1000 is for example a remote server of the cloud or a diagnostic tool.

Such a link allows the communication device 11 to transmit information or data, for example information received from the sensors 12 to 14 and from the sensor 131 associated with one or more of these computers, for example the computer 13, to the external device for the supply of data from the on-board system 100, for example via the Internet with an OTA (“over-the-air”) type connection. The OTA-type connection for example uses one or more wireless communication protocols such as Bluetooth®, Wi-Fi® (based on IEEE 802.11), LTE (“Long-Term Evolution”) or LTE-Advanced.

The sensor 131 is connected to the computer 13 via a wired connection, for example by using a technology of the LIN (“Local Interconnect Network”) bus type.

The communication device 11 is for example configured to implement one or more of the following functions:
monitoring the geographic positioning of the vehicle, by means of location data obtained from a satellite positioning system 1001, called GNSS (Global Navigation Satellite System), for example of the GPS (“Global Positioning System”) type;
communication with one or more external devices via one or more communication interfaces, transmission of geolocation information;
communication of information or data for the management of the vehicle, such as for example fuel consumption, kilometers travelled, journey times, CO₂ emissions, etc., for example via one or more communication interfaces of the Wi-Fi® or Bluetooth® type, these data for example being received from one or more computers of the vehicle's on-board system;
communication of mobile data via one or more wireless communication interfaces configured to communicate with one or more wireless networks of the cellular type, for example a network of the GSM, GPRS, LTE 4G or 5G type;
dedicated short-range communications (or DSRC) for example in the context of the so-called connected car according to a vehicle-to-everything (V2X) communication mode, based on the IEEE 802.11p standard, such short-range communications being intended for electronic toll collection, cooperative vehicle speed control, cooperative frontal collision detection, emergency vehicle approach warning and many other applications;
communication according to LTE-V Mode 4 (“Long-Term Evolution—Vehicle Mode 4”) technology which allows vehicle-to-vehicle (V2V) communications, also called “sidelink” communications, based on a direct LTE communication interface called PC5.

The functions and/or communications listed above are implemented by one or more microcontrollers associated with one or more modems integrated into the communication device 11.

The control of the parameters of the communication device 11 so as to control the temperature of this communication device is advantageously implemented by the communication device 11, or by one or more components of this communication device 11, for example a microcontroller associated with a memory and connected to one or more temperature sensors.

In a first operation, one or more items of information represents temperature in the communication device. This information is for example received from a temperature sensor integrated in the communication device. According to another example, this information is received from a temperature sensor arranged outside the communication device, for example at the periphery of the communication device, and configured to measure the temperature inside the communication device. This information is for example received by a processing unit (for example a microcontroller) integrated in, or remote from, the communication device.

The temperature information is for example received automatically, without requesting it, for example at regular intervals (for example every 1, 5, 10, 30 seconds). According to a variant, the frequency at which the temperature information is reported increases when the temperature exceeds a threshold value. According to this variant, when the temperature increases and approaches a critical value, that is to say, a temperature value likely to damage one or more components of the communication device, the temperature measurement frequency increases (for example every second if the previous frequency was every 10 or 30 seconds) to precisely monitor whether the temperature continues to increase or, on the contrary, decreases.

According to another example, the temperature is measured by the temperature sensor each time a request is received, sent for example by the processing unit in charge of controlling the temperature.

In a second operation, one or more control parameters of one or more functions provided by the communication device are controlled according to the item(s) of temperature information received. Controlling these parameters makes it possible, for example, to reduce the functional load of the communication device when an excessive temperature is observed, that is to say, when the temperature is greater than a threshold, the reduction in the load for example being a function of (e.g. proportional to) the increase in measured temperature. Conversely, if the temperature is within a nominal operating range of the communication device, the functional load of the communication device is increased, for example on receipt of a request (for example implementation of a new communication link in addition to those that already exist).

Controlling the control parameter(s) makes it possible, for example, to obtain one or more of the following effects:
reduction or stopping of the charging of a backup battery, for example an external battery;
reduction of service until the Wi-Fi® module is stopped, such a module for example comprising a Wi-Fi® router, the reduction of the Wi-Fi® service corresponding for example to a reduction in the transmission and/or reception power, a reduction in the number frequency channels and/or frequency bands used, a reduction in bandwidth;
service reduction until the Bluetooth® module is stopped, such a module for example comprising a Bluetooth® router, the reduction of the corresponding Bluetooth® service being accomplished, for example by reducing the transmission and/or reception power, reducing the number frequency channels and/or frequency bands used, a reduction in bandwidth;
service reduction until the LTE 4G or 5G module is stopped, the reduction of the corresponding LTE 4G or 5G service being accomplished, for example, by reducing the transmission and/or reception power, reducing the number of frequency channels and/or frequency bands used, a reduction in bandwidth;
stopping the radio module, such a module corresponding, for example, to a radio tuner;
implementation of a thermal attenuation algorithm;
reduction of the clock frequency of the processor(s) of the communication device, with the effect of reducing the number of instructions executed per second;
stopping or deactivating the functionality managing the certification authority of the communication device in the implementation of a public key infrastructure (PKI);
reduction or filter of the throughput of messages sent/received in the context of vehicle-to-everything (V2X) type communication;
reduction of the scanning frequency of the GNSS system, for example from 10 kHz to 1 kHz;
stopping or switching off a core of one or more processors when the processor(s) of the communication device are of the multi-core type;
reduction of the throughput of the uplink and/or downlink, that is to say, reduction of the bandwidth;
shutdowns of all communication services except emergency services;
shutdown of the power management integrated circuit.

According to a particular embodiment, the control parameters are controlled to reduce the functions performed by the communication device when the temperature measured in the communication device increases until it exceeds a threshold value. The number of degraded or stopped functions or services is for example a function of the measured increase in temperature, this number increasing with the increase in temperature. The control parameters are for example controlled to reduce the services (at least partially) according to a first determined order, also called first deactivation order. For example, the services or functions ensured by the communication device and not directly concerning the safety of the vehicle are stopped or degraded first. For example, the charging of the external battery is stopped first, then the Wi-Fi link, then the Bluetooth link, then the 4G link, then the V2X communication services with the exception of emergency messages (for example DENM messages), eventually shutting down the power management IC. For example, stopping each of the functions (or switching to degraded mode) depends on a threshold temperature reached by the communication device. For example, the charging of the external battery is stopped when a first temperature threshold value is reached, then the Bluetooth link when a first temperature threshold value greater than the first threshold value is reached, then the 4G link is stopped when a third temperature threshold value greater than the second threshold value is reached, and so on.

Parameter control to reduce the functional load of the communication device for example follows the order of the above list, showing the effects associated with parameter control.

In parallel with the stopping of certain functions and/or the transition to degraded mode depending on the increase in temperature, cooling means (for example a fan) of the communication device is activated when the temperature reaches and/or exceeds the threshold value in the communication device.

According to another alternative embodiment, the deactivated or degraded function(s) are put back into service as the temperature in the communication device decreases. According to this variant, all the functions normally provided by the communication device 11 are put back into service when the item(s) of temperature information received from the temperature sensor indicate that the temperature in the communication device 11 has dropped below the value threshold.

The return to service of the partially deactivated or degraded functions is accomplished for example according to a second determined order, for example in the reverse order of the first order of deactivation, for example in the reverse order of the list above (starting from the last item in the list and going back to the first item).

According to another embodiment, before implementing a function at the request of a third-party device of the vehicle (for example the multimedia system of the vehicle), the communication device 11 or the device in charge of controlling the temperature of the communication device checks that the temperature inside the communication device is normal or below a determined threshold allowing the implementation of the requested function.

Of course, the number of computers in the system 100 is not limited to 3 and extends to any number, for example 10, 20, 50, 100 or more computers. An example of a hardware embodiment of a communication device 11 or of a device configured to control the temperature via the control of the parameters of the communication device 11 is described with regard to FIG. 2.

FIG. 2 schematically illustrates a device 2 configured to control the communication device 11 of FIG. 1. The device 2 for example corresponds to a computer of the on-board system of the vehicle or to the communication device 11 or to a part of the communication device 11.

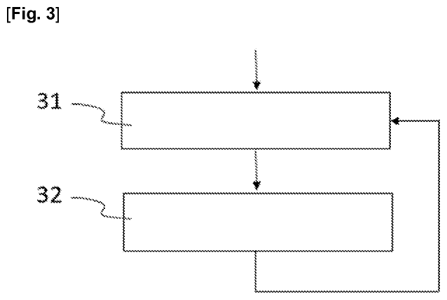

The device 2 is for example configured to implement the operations described with regard to FIG. 1 and/or the steps of the method described with regard to FIG. 3. Examples of such a computer 2 comprise, without being limited thereto, a telematic control unit (TCU), on-board electronic equipment such as an on-board computer of a vehicle, an electronic computer such as an ECU (Electronic Control Unit). The elements of the device 2, individually or in combination, can be integrated in a single integrated circuit, in several integrated circuits and/or in discrete components. The computer 2 may be produced in the form of electronic circuits or of software (or computer) modules, or else of a combination of electronic circuits and software modules. According to various particular embodiments, the device 2 is coupled in communication with other devices or similar systems, for example by means of a communication bus or through dedicated input/output ports.

The device 2 comprises one (or more) processor(s) 20 and/or one or more microcontrollers configured to execute instructions for carrying out the steps of the method and/or for executing the instructions of the software embedded in the device 2. The processor 20 may include integrated memory, an input/output interface and various circuits known to those skilled in the art. The device 2 further comprises at least one memory 21 corresponding for example to a volatile and/or non-volatile memory and/or comprises a memory storage device that may comprise volatile and/or non-volatile memory, such as EEPROM, ROM, PROM, RAM, DRAM, SRAM, flash, magnetic or optical disk.

The computer code of the on-board software application(s) comprising the instructions to be loaded and executed by the processor is for example stored in the first memory 21.

According to a particular and non-limiting embodiment, the device 2 comprises one or more temperature sensors 24, for example a silicon temperature sensor or a sensor operating as a two-terminal Zener diode, providing temperature information on a few bits, for example on 8, 10, 12, or 14 bits. According to another example, the temperature sensor(s) correspond(s) to a linear analog temperature sensor with a CMOS (“Complementary Metal Oxide Semiconductor”) integrated circuit with an output voltage proportional to the temperature.

According to a particular and non-limiting embodiment, the device 2 comprises a block 22 of interface elements for communicating with external devices, for example a remote server or the cloud, nodes of an ad hoc network (for example in the context of a communication system of the ITS G5 or DSRC type), communication antennas of a cellular network. The interface elements of the block 22 comprise one or more of the following interfaces:
radiofrequency (RF) interface, for example of the Bluetooth® or Wi-Fi® type, LTE (“Long-Term Evolution”) and/or LTE-Advanced;
USB interface (“Universal Serial Bus”);
HDMI interface (“High-Definition Multimedia Interface”).

Data are for example loaded into the device 2 via the interface of the block 22 using a Wi-Fi® network such as according to IEEE 802.11, an ITS G5 network based on IEEE 802.11p or a mobile network such as a 4G (or LTE Advanced according to 3GPP release 10—version 10), or 5G network, for example a LTE-V2X network.

According to another particular embodiment, the device 2 comprises a communication interface 23 that makes it possible to establish communication with other devices (such as other computers of the on-board system when the device 2 corresponds to a computer of the on-board system) via a communication channel 230. The communication interface 23 for example corresponds to a transmitter configured to transmit and receive information and/or data via the communication channel 230. The communication interface 23 corresponds for example to a wired network of the CAN (“Controller Area Network”), CAN FD (“Controller Area Network Flexible Data-Rate”) or FlexRay type.

According to an additional particular embodiment, the device 2 can provide output signals to one or more external devices, such as a display screen, one or more loudspeakers and/or other peripherals respectively via output interfaces not shown.

FIG. 3 illustrates a flowchart of the different steps of a method for controlling the communication device 11 of a vehicle, according to a particular and non-limiting embodiment of the present invention. The method is for example implemented by the communication device 11, which itself is on-board a vehicle, or by the device 2 of FIG. 2.

In a first step 31, one or more items of information representative of temperature in the communication device are received, for example by a processor or a microcontroller, for example integrated into the communication device 11.

In a second step 32, one or more control parameters of functions provided by the communication device are controlled according to the item(s) of temperature information. The parameter(s) allow deactivation or stopping of one or more functions, or at least part of these functions. The deactivation of part of a function corresponds for example to a switch to degraded mode of the associated function, that is to say, passage to a mode where the capacities or performance of the function are reduced (for example reduction of the bit rate). Conversely, the controlled parameter(s) allow activation or reactivation of the deactivated function(s), or other optional functions used in particular situations, for example on request.

Steps 31 and 32 are advantageously repeated to regularly control the temperature in the communication device 11 and to adapt the functional load of the communication device 11 (that is to say, the spectrum or the set of functions provided by the communication device 11) accordingly.

Of course, the method and control device are not limited to the embodiments described above, but extend to a method for controlling the temperature of a communication device and to the control device configured for the implementation of such a method.

An on-board vehicle system comprising the communication device 11 is also contemplated.

Additionally, a vehicle, for example an automobile or more generally a land motor vehicle, comprising the device 2 of FIG. 2 and/or the on-board system 100 of FIG. 1 is contemplated.

1. A method for controlling a communication device of a vehicle, the method comprising the following steps:
receiving at least one item of information representative of at least one temperature in said communication device; and
controlling control parameters of functions performed by said communication device as a function of said at least one item of information.

2. The method according to claim 1, wherein said control parameters are controlled so as to deactivate, at least in part, each function of a set of functions comprising at least one of said functions performed by said communication device when said at least one item of information is representative of a temperature increase above a threshold value in said communication device.

3. The method according to claim 2, wherein said set of functions comprises a determined number of functions, said determined number of functions being a function of said increase in temperature, said determined number of functions increasing with the increase in temperature.

4. The method according to claim 2, wherein said control parameters are controlled according to a first determined order to at least partially deactivate each function of said set of functions.

5. The method according to claim 2, further comprising a step of cooling said communication device when said at least one item of information is representative of an increase in temperature beyond said threshold value in said communication device.

6. The method according to claim 2, wherein each function of said set of functions deactivated at least in part is reactivated when said at least one item of information is representative of a decrease in temperature below said threshold value in said communication device.

7. The method according to claim 6, wherein said control parameters are controlled according to a second determined order to reactivate each function of said set of functions.

8. A device for controlling a vehicle communication device, said device comprising a memory associated with a processor configured to implement the steps of the method according to claim 1.

9. The device according to claim 8, further comprising at least one temperature sensor configured to measure the temperature in said communication device.

10. A vehicle comprising the device according to claim 8.
